(19) United States
(12) Patent Application Publication
(10) Pub. No.: US 2025/0390998 A1
(43) Pub. Date: Dec. 25, 2025

(54) GENERATIVE PHOTO UNCROPPING AND RECOMPOSITION

(71) Applicant: Google LLC, Mountain View, CA (US)

(72) Inventors: Selena SHANG, Mountain View, CA (US); Alex Rav ACHA, Mountain View, CA (US); Sarah TRAN, Mountain View, CA (US); Clement NG, Mountain View, CA (US); Bryan FELDMAN, Mountain View, CA (US); Navin SARMA, Mountain View, CA (US); Yakir GORSKI, Mountain View, CA (US)

(73) Assignee: Google LLC, Mountain View, CA (US)

(21) Appl. No.: 19/247,315

(22) Filed: Jun. 24, 2025

Related U.S. Application Data
(60) Provisional application No. 63/663,536, filed on Jun. 24, 2024.

(51) Int. Cl. G06T 5/77; G06T 5/60; G06T 7/11; G06T 11/60

(52) U.S. Cl. CPC G06T 5/77; G06T 5/60; G06T 7/11; G06T 11/60; G06T 2200/24; G06T 2207/20081; G06T 2207/20132; G06T 2207/30196

(57) ABSTRACT

A media application receives an input image that includes a subject. The media application segments the subject from the input image. The media application generates, based on segmenting the subject, a subject mask that includes subject pixels associated with the subject. The media application determines, based on the subject mask, whether a portion of the subject is cut off by one or more borders of the input image. Responsive to the portion of the subject not being cut off, the media application provides the input image and the subject mask as input to an inpainter machine-learning model. The media application generates, with the inpainter machine-learning model, an output image that extends one or more borders of the input image by adding inpainted pixels to the input image.

### CROSS-REFERENCE TO RELATED APPLICATIONS

This application is a non-provisional application that claims priority under 35 U.S.C. § 119(e) to U.S. Provisional Patent Application No. 63/663,536, filed on Jun. 24, 2024 and entitled “Generative Photo Uncropping and Recomposition,” which is hereby incorporated by reference herein in its entirety.

### TECHNICAL FIELD

This disclosure relates generally to using generative artificial intelligence to enhance an image, and more particularly relates to methods, systems, and computer readable media to uncrop and recompose an input image.

### BACKGROUND

A user may capture an image where objects are cut off. For example, a user may capture an image where part of a house is cut off. If a user realizes the mistake after leaving the place where the image was taken, the user may be dissatisfied with the image. It may be at best inconvenient and at worst not possible to go back and retake the image.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computer-implemented method to uncrop an input image includes receiving an input image that includes a subject. The method further includes segmenting the subject from the input image. The method further includes generating, based on segmenting the subject, a subject mask that includes subject pixels associated with the subject. The method further includes determining, based on the subject mask, whether a portion of the subject is cut off by one or more borders of the input image. The method further includes responsive to the portion of the subject not being cut off by the one or more borders, providing the input image and the subject mask as input to an inpainter machine-learning model. The method further includes generating, with the inpainter machine-learning model, an output image that extends one or more borders of the input image by adding inpainted pixels to the input image.

In some embodiments, the inpainter machine-learning model extends the one or more borders of the input image by an amount that places the subject in a center of the output image. In some embodiments, generating the output image includes recomposition of the input image such that one or more portions associated with the input image are removed.

In some embodiments, the inpainter machine-learning model is trained using training data and the method further includes generating a set of training images as the training data by: receiving ground truth images; masking one or more borders in each ground truth image; and pairing each masked image with a corresponding ground truth image to form the set of training images. In some embodiments, the inpainter machine-learning model is further trained by: receiving initial images; for each of the initial images, cropping one or more borders to form a ground truth image; for each of the initial images, making one or more borders to form one or more masked images; and pairing each masked image with a corresponding ground truth image to form the set of training images, wherein each corresponding ground truth image is a recomposition of the masked image. In some embodiments, the inpainter machine-learning model is trained by: providing a user interface that includes the ground truth images to one or more users; receiving feedback from the user that includes a rating for each of the ground truth images; and training the inpainter model based on ratings associated with the ground truth images.

In some embodiments, the inpainter machine-learning model is trained using training data and the method further includes generating a set of training images as the training data by: receiving ground truth images, each ground truth image having an image subject; cropping the ground truth images to create first cropped ground truth images and second cropped ground truth images, wherein the first cropped ground truth images include the image subject in a center of the first cropped ground truth images and the second cropped ground truth images include the image subject off-of-center; generating a user interface that includes the first cropped ground truth images and the second cropped ground truth images; receiving feedback from one or more users that includes ratings for each of the first cropped ground truth images and the second cropped ground truth images; masking one or more borders in each of the first cropped ground truth images and the second cropped ground truth images; and grouping each masked image with a corresponding first cropped ground truth image and a corresponding second cropped ground truth image to form the set of training images, wherein the set of training images include corresponding ratings. In some embodiments, generating the output image includes: determining whether the subject is a person is in the input image; and responsive to the subject being the person, applying a subject mask to the person during generation of the output image to prevent modification of at least a face of the person.

A computer-implemented method to train an inpainter machine-learning model to uncrop an input image includes generating training data for the inpainter machine-learning model by: receiving ground truth images; masking one or more borders in each ground truth image; and pairing each masked image with a corresponding ground truth image to form a set of training images. The method further includes training the inpainter machine-learning model to: receive an input image and a corresponding subject mask as input; and output an output image that extends one or more borders of the input image by adding inpainted pixels to the input image.

In some embodiments, the inpainter machine-learning model is further trained to extend the one or more borders of the input image by an amount that places the subject in a center of the output image. In some embodiments, the inpainter machine-learning model is further trained by: presenting the ground truth images to one or more users; receiving feedback from the one or more users that includes a rating for each of the ground truth images; and training the inpainter model based on ratings associated with the ground truth images. In some embodiments, the one or more users are trained to identify a quality of the ground truth images.

In some embodiments, generating training data for the inpainter machine-learning model further includes: cropping the ground truth images to create first cropped ground truth images and second cropped ground truth images, wherein the first cropped ground truth images include the image subject in a center of the first cropped ground truth images and the second cropped ground truth images include the image subject off-of-center; generating a user interface that includes the first cropped ground truth images and the second cropped ground truth images; receiving feedback from one or more users that includes ratings for each of the first cropped ground truth images and the second cropped ground truth images; masking one or more borders in each of the first cropped ground truth images and the second cropped ground truth images; and grouping each masked image with a corresponding first cropped ground truth image and a corresponding second cropped ground truth image to form the set of training images, wherein the set of training images include corresponding ratings. In some embodiments, the inpainted pixels are based on a similarity to original pixels in the input image and the similarity is a function of a distance from a particular inpainted pixel to a particular original pixel.

In some embodiments, a non-transitory computer-readable medium with instructions stored thereon that, when executed by one or more processors, cause the one or more processors to perform operations. The operations include receiving an input image that includes a subject; segmenting the subject from the input image; generating, based on segmenting the subject, a subject mask that includes subject pixels associated with the subject; determining, based on the subject mask, whether a portion of the subject is cut off by one or more borders of the input image; responsive to the portion of the subject not being cut off by the one or more borders, providing the input image and the subject mask as input to an inpainter machine-learning model; and generating, with the inpainter machine-learning model, an output image that extends one or more borders of the input image by adding inpainted pixels to the input image.

In some embodiments, the inpainter machine-learning model extends the one or more borders of the input image by an amount that places the subject in a center of the output image. In some embodiments, generating the output image includes recomposition of the input image such that one or more portions associated with the input image are removed.

In some embodiments, the inpainter machine-learning model is trained using training data and the operations further include generating a set of training images as the training data by: receiving ground truth images; masking one or more borders in each ground truth image; and pairing each masked image with a corresponding ground truth image to form the set of training images. In some embodiments, the inpainter machine-learning model is further trained by: receiving initial images; for each of the initial images, cropping one or more borders to form a ground truth image; for each of the initial images, making one or more borders to form one or more masked images; and pairing each masked image with a corresponding ground truth image to form the set of training images, wherein each corresponding ground truth image is a recomposition of the masked image. In some embodiments, the inpainter machine-learning model is trained by: providing a user interface that includes the ground truth images to one or more users; receiving feedback from the user that includes a rating for each of the ground truth images; and training the inpainter model based on ratings associated with the ground truth images.

In some embodiments, the inpainter machine-learning model is trained using training data and the operations further include generating a set of training images as the training data by: receiving ground truth images; cropping the ground truth images to create first cropped ground truth images and second cropped ground truth images, wherein the first cropped ground truth images include the image subject in a center of the first cropped ground truth images and the second cropped ground truth images include the image subject off-of-center; generating a user interface that includes the first cropped ground truth images and the second cropped ground truth images; receiving feedback from one or more users that includes ratings for each of the first cropped ground truth images and the second cropped ground truth images; masking one or more borders in each of the first cropped ground truth images and the second cropped ground truth images; and grouping each masked image with a corresponding first cropped ground truth image and a corresponding second cropped ground truth image to form the set of training images, wherein the set of training images include corresponding ratings.

### BRIEF DESCRIPTION OF THE DRAWINGS

FIG. 1 is a block diagram illustrating an example network environment, according to some embodiments described herein.

FIG. 2 is a block diagram illustrating an example computing device, according to some embodiments described herein.

FIG. 3 is an example user interface for provide a rating for an image, according to some embodiments described herein.

FIG. 4 is a block diagram illustrating an example diffusion model, according to some embodiments described herein.

FIG. 5 illustrates example images used for training data, according to some embodiments described herein.

FIG. 6 illustrates example ground truth images with varying quality scores for training purposes, according to some embodiments described herein.

FIG. 7 illustrates an example process for creating a recomposed ground truth image for training data, according to some embodiments described herein.

FIG. 8 illustrates example user interfaces for different types of images, according to some embodiments described herein.

FIG. 9 is a flowchart illustrating an example method to train an inpainter machine-learning model to uncrop an input image, according to some embodiments described herein.

FIG. 10 is a flowchart illustrating an example method to generate an output image that is uncropped, according to some embodiments described herein.

### DETAILED DESCRIPTION

### Overview

Existing digital image processing techniques attempt to address scenarios where a captured image has objects that are cut off by the frame's boundaries. Some image editing applications endeavor to correct this problem by employing generative artificial intelligence to extend the image, a process commonly referred to as “uncropping.”

However, current uncropping techniques exhibit significant limitations. These methods frequently generate new pixel data for the extended areas without sufficient contextual understanding of the original image's content. This often results in output images that appear unrealistic or introduce visual artifacts. For instance, if an animal subject is partially cut off by an image border, existing generative algorithms may produce distorted facial features for the animal or unnatural textures when attempting to complete the subject. Similarly, background elements that are synthesized to extend the scene may lack coherence with the original image content, leading to a noticeable discontinuity or an overall “odd” appearance. The lack of robust mechanisms for preserving the fidelity of existing image content while intelligently generating new content remains an unresolved challenge in the field.

The technology described below advantageously describes herein an inpainted machine-learning model that generates output images where one or more borders of an input image are extended by adding inpainted pixels, thereby improving a quality of the image. The technology also advantageously avoids a need for the user to return to the same location and capture additional images. As a result, the storage demands are reduced because the user has one high-quality image instead of a set of subpar images.

In some embodiments, the inpainted machine-learning model generates output images that extend the one or more borders of the input image enough to center a subject in the image. In some embodiments, a recompose machine-learning model receives output images from the inpainted machine-learning model and generates recomposed output images that are recomposed (e.g., cropped) as compared to the input images.

The inpainted machine-learning model is trained to generate the output images by creating a training data set by, for each ground truth image, masking a portion of the ground truth image and pairing the masked image with the corresponding ground truth image. The training data is used as a guide to train the inpainter machine-learning model to receive an input image that is similar to the masked images and to output an uncropped image that is similar to the ground truth images. In some embodiments, the training data may include multiple versions of a ground truth image that are cropped and masked and associated with different ratings to create different versions of ground truth images with differing quality.

### Network Environment

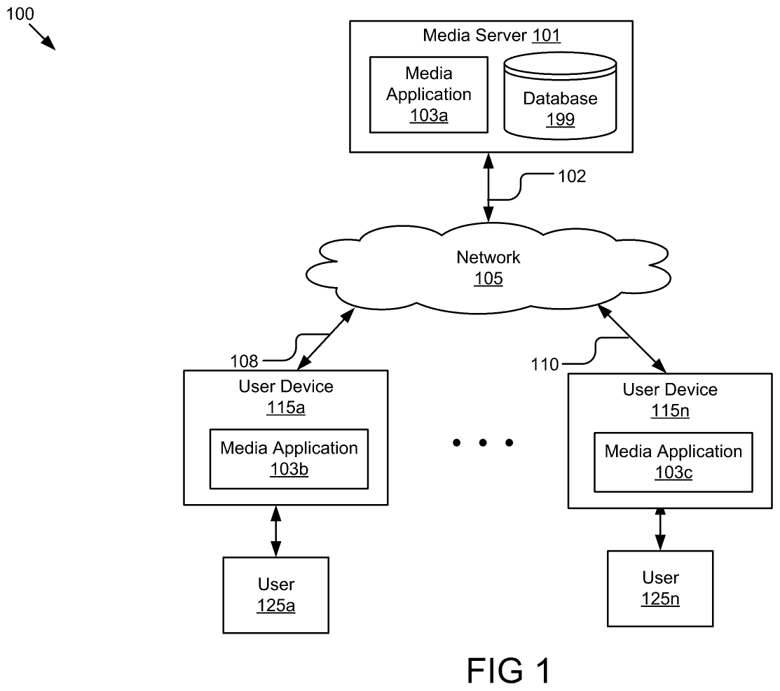

FIG. 1 is a block diagram of an example network environment 100, according to some embodiments described herein. In some embodiments, the network environment 100 includes a media server 101, a user device 115a, and a user device 115n coupled to a network 105. Users 125a, 125n may be associated with respective user devices 115a, 115n. In some embodiments, the network environment 100 may include other servers or devices not shown in FIG. 1. In FIG. 1 and the remaining figures, a letter after a reference number, e.g., “115a,” represents a reference to the element having that particular reference number. A reference number in the text without a following letter, e.g., “115,” represents a general reference to embodiments of the element bearing that reference number.

The media server 101 may include a processor, a memory, and network communication hardware. In some embodiments, the media server 101 is a hardware server. The media server 101 is communicatively coupled to the network 105 via signal line 102. Signal line 102 may be a wired connection, such as Ethernet, coaxial cable, fiber-optic cable, etc., or a wireless connection, such as Wi-Fi®, Bluetooth®, or other wireless technology. In some embodiments, the media server 101 sends and receives data to and from one or more of the user devices 115a, 115n via the network 105. The media server 101 may include a media application 103a and a database 199.

The database 199 may store machine-learning models, training data sets, images, etc. The database 199 may also store social network data associated with users 125, user preferences for the users 125, etc.

The user device 115 may be a computing device that includes a memory coupled to a hardware processor. For example, the user device 115 may include a mobile device, a tablet computer, a mobile telephone, a wearable device, a head-mounted display, a mobile email device, a portable game player, a portable music player, a reader device, or another electronic device capable of accessing a network 105.

In the illustrated embodiment, user device 115a is coupled to the network 105 via signal line 108 and user device 115n is coupled to the network 105 via signal line 110. The media application 103 may be stored as media application 103b on the user device 115a and/or media application 103c on the user device 115n. Signal lines 108 and 110 may be wired connections, such as Ethernet, coaxial cable, fiber-optic cable, etc., or wireless connections, such as Wi-Fi®, Bluetooth®, or other wireless technology. User devices 115a, 115n are accessed by users 125a, 125n, respectively. The user devices 115a, 115n in FIG. 1 are used by way of example. While FIG. 1 illustrates two user devices, 115a and 115n, the disclosure applies to a system architecture having one or more user devices 115.

The media application 103 may be stored on the media server 101 or the user device 115. In some embodiments, the operations described herein are performed on the media server 101 or the user device 115. In some embodiments, some operations may be performed on the media server 101 and some may be performed on the user device 115. Performance of operations is in accordance with user settings. For example, the user 125a may specify settings that operations are to be performed on their respective device 115a and not on the media server 101. With such settings, operations described herein are performed entirely on user device 115a and no operations are performed on the media server 101. Further, a user 125a may specify that images and/or other data of the user is to be stored only locally on a user device 115a and not on the media server 101. With such settings, no user data is transmitted to or stored on the media server 101. Transmission of user data to the media server 101, any temporary or permanent storage of such data by the media server 101, and performance of operations on such data by the media server 101 are performed only if the user has agreed to transmission, storage, and performance of operations by the media server 101. Users are provided with options to change the settings at any time, e.g., such that they can enable or disable the use of the media server 101.

Machine learning models (e.g., a Generative Adversarial Network (GAN), neural networks, convolutional neural networks, deep learning, or other types of models), if utilized for one or more operations, are stored and utilized locally on a user device 115, with specific user permission. Server-side models are used only if permitted by the user. Further, a trained model may be provided for use on a user device 115. During such use, if permitted by the user 125, on-device training of the model may be performed. Updated model parameters may be transmitted to the media server 101 if permitted by the user 125, e.g., to enable federated learning. Model parameters do not include any user data.

The media application 103 receives an input image that includes a subject. For example, the media application 103 receives an input image from a camera that is part of the user device 115 or the media application 103 receives the input image over the network 105. The media application 103 segments the subject from the input image. For example, the media application 103 generates a segmentation map that identifies subject pixels associated with the subject and remaining pixels that are not associated with the subject. The media application 103 generates, based on segmenting the subject, a subject mask that includes subject pixels associated with the subject.

The media application 103 determines, based on the subject mask, whether a portion of the subject is cut off by one or more borders of the input image. If the subject is not cut off by one or more borders of the input image, the media application 103 provides the input image and the subject mask as input to an inpainter machine-learning model. The inpainter machine-learning model generates an output image that extends one or more borders of the input image by adding inpainted pixels to the input image.

In some embodiments, the media application 103 may be implemented using hardware including a central processing unit (CPU), a field-programmable gate array (FPGA), an application-specific integrated circuit (ASIC), machine learning processor/co-processor, any other type of processor, or a combination thereof. In some embodiments, the media application 103a may be implemented using a combination of hardware and software.

### Computing Device

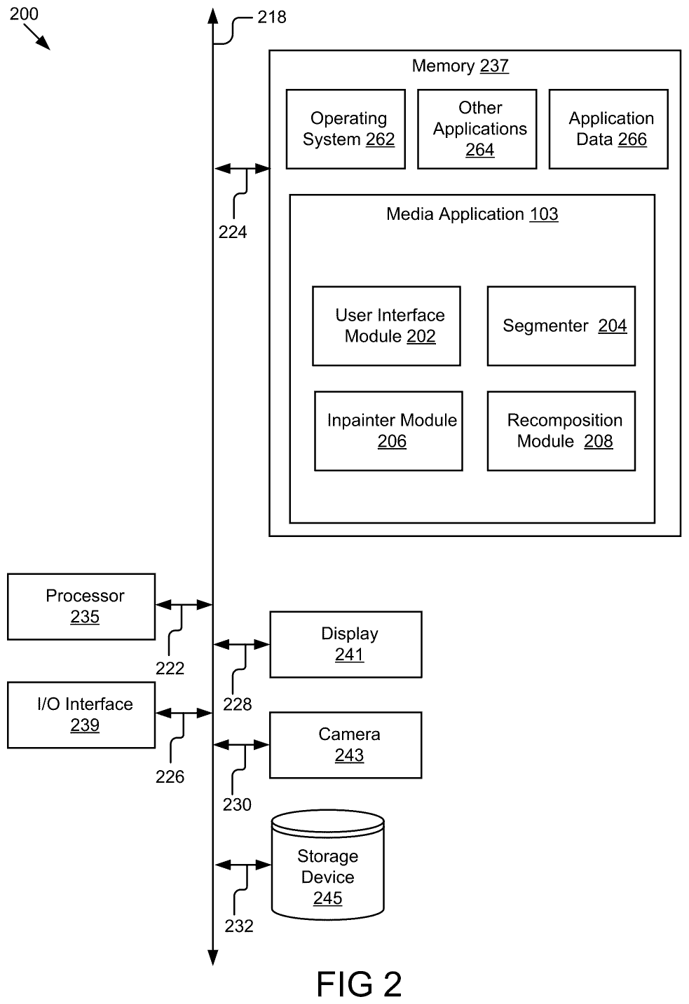

FIG. 2 is a block diagram illustrating an example computing device 200 that may be used to implement one or more features described herein. Computing device 200 can be any suitable computer system, server, or other electronic or hardware device. In one example, computing device 200 is media server 101 used to implement the media application 103a. In another example, computing device 200 is a user device 115.

In some embodiments, computing device 200 includes a processor 235, a memory 237, an input/output (I/O) interface 239, a display 241, a camera 243, and a storage device 245 all coupled via a bus 218. The processor 235 may be coupled to the bus 218 via signal line 222, the memory 237 may be coupled to the bus 218 via signal line 224, the I/O interface 239 may be coupled to the bus 218 via signal line 226, the display 241 may be coupled to the bus 218 via signal line 228, the camera 243 may be coupled to the bus 218 via signal line 230, and the storage device 245 may be coupled to the bus 218 via signal line 232.

Processor 235 can be one or more processors and/or processing circuits to execute program code and control basic operations of the computing device 200. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems. In some embodiments, processor 235 may include one or more co-processors that implement neural-network processing. In some embodiments, processor 235 may be a processor that processes data to produce probabilistic output, e.g., the output produced by processor 235 may be imprecise or may be accurate within a range from an expected output. Processing need not be limited to a particular geographic location or have temporal limitations. For example, a processor may perform its functions in real-time, offline, in a batch mode, etc. Portions of processing may be performed at different times and at different locations, by different (or the same) processing systems. A computer may be any processor in communication with a memory.

Memory 237 is provided in computing device 200 for access by the processor 235, and may be any suitable processor-readable storage medium, such as random access memory (RAM), read-only memory (ROM), Electrical Erasable Read-only Memory (EEPROM), Flash memory, etc., suitable for storing instructions for execution by the processor or sets of processors, and located separate from processor 235 and/or integrated therewith. Memory 237 can store software operating on the computing device 200 by the processor 235, including a media application 103.

The memory 237 may include an operating system 262, other applications 264, and application data 266. Other applications 264 can include, e.g., an image library application, an image management application, an image gallery application, communication applications, web hosting engines or applications, media sharing applications, etc. One or more methods disclosed herein can operate in several environments and platforms, e.g., as a stand-alone computer program that can run on any type of computing device, as a web application having web pages, as a mobile application (“app”) run on a mobile computing device, etc.

The application data 266 may be data generated by the other applications 264 or hardware of the computing device 200. For example, the application data 266 may include images used by the image library application and user actions identified by the other applications 264 (e.g., a social networking application), etc.

I/O interface 239 can provide functions to enable interfacing the computing device 200 with other systems and devices. Interfaced devices can be included as part of the computing device 200 or can be separate and communicate with the computing device 200. For example, network communication devices, storage devices (e.g., memory 237 and/or storage device 245), and input/output devices can communicate via I/O interface 239. In some embodiments, the I/O interface 239 can connect to interface devices such as input devices (keyboard, pointing device, touchscreen, microphone, scanner, sensors, etc.) and/or output devices (display devices, speaker devices, printers, monitors, etc.).

Some examples of interfaced devices that can connect to I/O interface 239 can include a display 241 that can be used to display content, e.g., images, video, and/or a user interface of an output application as described herein, and to receive touch (or gesture) input from a user. For example, display 241 may be utilized to display a user interface that includes a graphical guide on a viewfinder. Display 241 can include any suitable display device such as a liquid crystal display (LCD), light emitting diode (LED), or plasma display screen, cathode ray tube (CRT), television, monitor, touchscreen, three-dimensional display screen, or other visual display device. For example, display 241 can be a flat display screen provided on a mobile device, multiple display screens embedded in a glasses form factor or headset device, or a monitor screen for a computer device.

Camera 243 may be any type of image capture device that can capture images and/or video. In some embodiments, the camera 243 captures images or video that the I/O interface 239 transmits to the media application 103.

The storage device 245 stores data related to the media application 103. For example, the storage device 245 may store a training data set that includes labeled images, a machine-learning model, output from the machine-learning model, etc.

FIG. 2 illustrates an example media application 103, stored in memory 237, that includes a user interface module 202, a segmenter 204, an inpainter module 206, and a recomposition module 208.

The user interface module 202 generates graphical data for displaying a user interface that includes images. In some embodiments, the user interface module 202 receives an input image. The input image may be received from the camera 243 of the computing device 200 or from the media server 101 via the I/O interface 239.

The input image includes a subject, such as a person or an animal or other objects (e.g., balloon, car, tree, or any other object that is captured in the input image). The user interface may include an option for modifying the input image. For example, the user interface may include an editing button, or a more specific button, such as an uncropping and/or recompose button. The user interface provides a user with a request for user consent. The media application 103 does not make use of user information unless the user provides user consent. In some embodiments, the user interface module 202 determines that the subject in the input image is off-of-center (e.g., to the left/right/top/bottom of the image center or combinations thereof) in the image and, as a result, suggests that the user select the uncropping and/or recompose button.

In some embodiments, the user interface module 202 generates a user interface that includes images to present to a user for feedback. For example, the user may provide a rating of each of the ground truth images that reflects a quality of the ground truth images. The ground truth images and the ratings (i.e., labels) may be used as training data for an inpainter machine-learning model as described in greater detail below. In another example, the user interface module 202 may include an output image generated by the inpainter machine-learning model during training. The inpainter module 206 may use feedback from the user about a quality of the output image to determine a difference between the output image and a ground truth image and refine the inpainter machine-learning model through training.

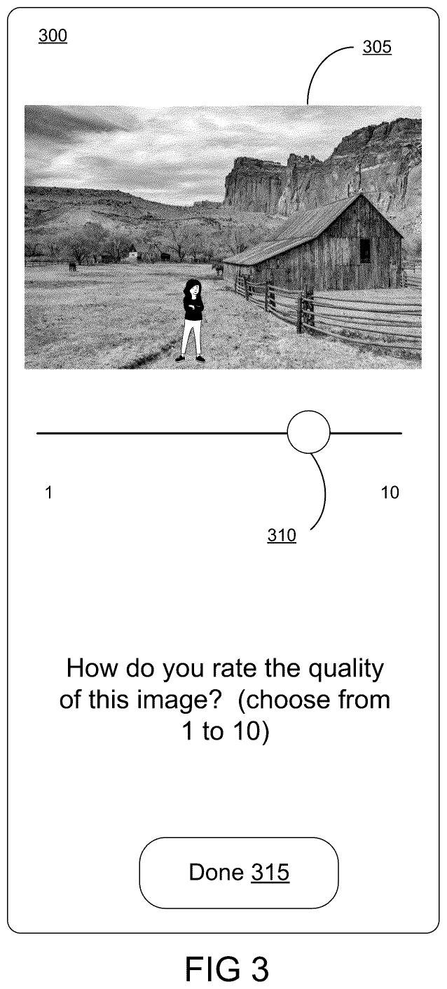

FIG. 3 is an example user interface 300 for providing a rating for an image 305, according to some embodiments described herein. The image may be a ground truth image, an output image, etc. A user is presented with the image 305 and asked to provide a rating from 1 to 10. The user moves a slider 310 to select a rating that matches a quality that the user associates with the image 305. Other ways of providing a rating are possible, such as a text field, a drop-down menu, etc. Other scales of ratings may also be used. Once the user is satisfied with the selected rating, the user selects the done button 315.

The segmenter 204 segments one or more subjects in an input image. The segmenter 204 identifies pixels associated with the one or more subjects from the input image. In some embodiments, the segmenter 204 identifies pixels associated with a portion of a subject, such as the subject's face and not the rest of the subject.

In some embodiments, the segmenter 204 generates a segmentation map that identifies pixels that are associated with the one or more subjects in the input image. For example, the segmentation map may include an identification of subject pixels associated with the one or more subjects and remaining pixels that are associated with the rest of the input image.

The segmenter 204 may perform segmentation by determining a foreground and background in the input image. In some embodiments, the segmenter 204 uses an alpha map as part of a technique for distinguishing the foreground and background of the input image during segmentation. In some embodiments, the segmenter 204 performs object recognition after determining the foreground and background in the input image or performs object recognition independent of determining the foreground and the background. The foreground may include objects that are a person, an animal, a car, a building, etc.

The segmenter 204 may detect types of objects by performing object recognition, comparing the objects to object priors of people, vehicles, buildings, etc. to identify known shapes of objects in order to determine whether pixels are associated with a subject. The segmenter 204 may generate a region of interest for the subject, such as a bounding box with x, y coordinates and a scale.

In some embodiments, one or more subject masks are generated based on generating superpixels for the image and matching superpixel centroids to depth map values (e.g., obtained by the camera 243 using a depth sensor or by deriving depth from pixel values) to cluster detections based on depth. More specifically, depth values in a masked area may be used to determine a depth range and superpixels may be identified that fall within the depth range. Another technique for generating a subject mask includes weighing depth values based on how close the depth values are to the subject mask where weights are represented by a distance transform map.

The segmenter 204 generates one or more subject masks for the one or more segmented subjects in the input image. The segmenter 204 uses the subject mask to determine whether a portion of the subject is cut off by one or more borders of the input image. If the segmenter 204 determines that the subject is cut off by one or more borders of the input image, the segmenter 204 determines that the input image is not eligible for uncropping. As a result of ensuring that the borders do not include a subject, the inpainter machine-learning model is not deployed in situations where the model may potentially generate unrealistic output images (using inpainting to extend portions of the subject) with a portion of the subject being generated from the inpainter machine-learning model.

In some embodiments, if the segmenter 204 determines based on object recognition that the subject is a person, the segmenter 204 may generate a subject mask that is used by the inpainter machine-learning model to prevent modification of at least a face of the person during generation of an output image. In some embodiments, the subject mask is used for one or more portions of the subject, such as portions of the person that are particularly susceptible to looking unrealistic during image generation, such as the face and/or the hands of the person.

In some embodiments, the segmenter 204 uses a machine-learning model, such as a neural network or more specifically, a convolutional neural network, to segment the input image and generate the subject mask. The segmenter 204 may specify a circuit configuration (e.g., for a programmable processor, for a field programmable gate array (FPGA), etc.) enabling processor 235 to apply a segmenter machine-learning model. In some embodiments, the segmenter 204 may include software instructions, hardware instructions, or a combination. In some embodiments, the segmenter 204 may offer an application programming interface (API) that can be used by the operating system 262 and/or other applications 264 to invoke the segmenter 204 e.g., to apply the segmenter machine-learning model to application data 266 to output the subject mask.

The segmenter 204 uses training data to generate a trained machine-learning model. For example, training data may include pairs of input images with one or more subjects and output images with one or more corresponding subject masks. Training data may be obtained from any source, e.g., a data repository specifically marked for training, data for which permission is provided for use as training data for machine learning, etc. In some embodiments, the training may occur on the media server 101 that provides the training data directly to the user device 115, the training occurs locally on the user device 115, or a combination of both.

In some embodiments, the segmenter 204 uses weights that are taken from another application and are unedited/transferred. For example, in these embodiments, the trained model may be generated, e.g., on a different device, and be provided as part of the segmenter 204. In various embodiments, the trained model may be provided as a data file that includes a model structure or form (e.g., that defines a number and type of neural network nodes, connectivity between nodes and organization of the nodes into a plurality of layers), and associated weights. The segmenter 204 may read the data file for the trained model and implement neural networks with node connectivity, layers, and weights based on the model structure or form specified in the trained model.

The trained machine-learning model may include one or more model forms or structures. For example, model forms or structures can include any type of neural-network, such as a linear network, a deep-learning neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that receives as input sequential data, such as words in a sentence, frames in a video, etc. and produces as output a result sequence), etc.

The model form or structure may specify connectivity between various nodes and organization of nodes into layers. For example, nodes of a first layer (e.g., an input layer) may receive data as input data or application data. Such data can include, for example, one or more pixels per node, e.g., when the trained model is used for analysis, e.g., of an input image. Subsequent intermediate layers may receive as input, output of nodes of a previous layer per the connectivity specified in the model form or structure. These layers may also be referred to as hidden layers. For example, a first layer may output a segmentation between a foreground and a background. A final layer (e.g., output layer) produces an output of the machine-learning model. For example, the output layer may receive the segmentation of the input image into a foreground and a background and output whether a pixel is part of a subject mask or the rest of the input image. In some embodiments, the model form or structure also specifies a number and/or type of nodes in each layer.

In different embodiments, the trained model can include one or more models. One or more of the models may include a plurality of nodes, arranged into layers per the model structure or form. In some embodiments, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output. In some embodiments, the computation performed by a node may also include applying a step/activation function to the adjusted weighted sum. In some embodiments, the step/activation function may be a nonlinear function. In various embodiments, such computation may include operations such as matrix multiplication. In some embodiments, computations by the plurality of nodes may be performed in parallel, e.g., using multiple processors cores of a multicore processor, using individual processing units of a graphics processing unit (GPU), or special-purpose neural circuitry. In some embodiments, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM).

In some embodiments, the trained model may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned or initialized to default values. The model may then be trained, e.g., using training data, to produce a result.

Training may include applying supervised learning techniques. In supervised learning, the training data can include a plurality of inputs (e.g., input images) and a corresponding ground truth output for each input (e.g., a ground truth mask that comprises correctly identified pixels corresponding to the subject in each image). Based on a comparison of the subject mask output by the model with the ground truth mask, values of the weights are automatically adjusted, e.g., in a manner that increases a probability that the model produces the ground truth mask for the input image.

In various embodiments, a trained model includes a set of weights, or embeddings, corresponding to the model structure. In some embodiments, the trained model may include a set of weights that are fixed, e.g., downloaded from a server that provides the weights. In various embodiments, a trained model includes a set of weights, or embeddings, corresponding to the model structure. In embodiments where data is omitted, the segmenter 204 may generate a trained model that is based on prior training, e.g., by a developer of the segmenter 204, by a third-party, etc. In some embodiments, the trained model may include a set of weights that are fixed, e.g., downloaded from a server that provides the weights.

In some embodiments, the trained segmenter machine-learning model receives an input image with one or more subjects. In some embodiments, the trained machine-learning model generates one or more subject masks that correspond to the one or more subjects in the input image.

The inpainter module 206 implements an impainter machine-learning model that generates an output image that extends one or more borders of the input image by adding inpainted pixels to the input image. As used herein, extending a border refers to extending a complete side of an image and not also the portions of the other sides that are also extended (e.g., if a left-hand border is extended that is meant to encompass portions of the top border and the bottom border that are also extended as a result of increasing a width of an image). In some embodiments, the one or more borders of the input image are extended in order to place the subject of the input image in a center of the output image.

The inpainter module 206 trains the inpainter machine-learning model to receive an input image and a subject mask as input and to generate an output image that includes inpainted pixels. In some embodiments, the inpainter machine-learning model includes a Generative Adversarial Network (GAN) or a diffusion model.

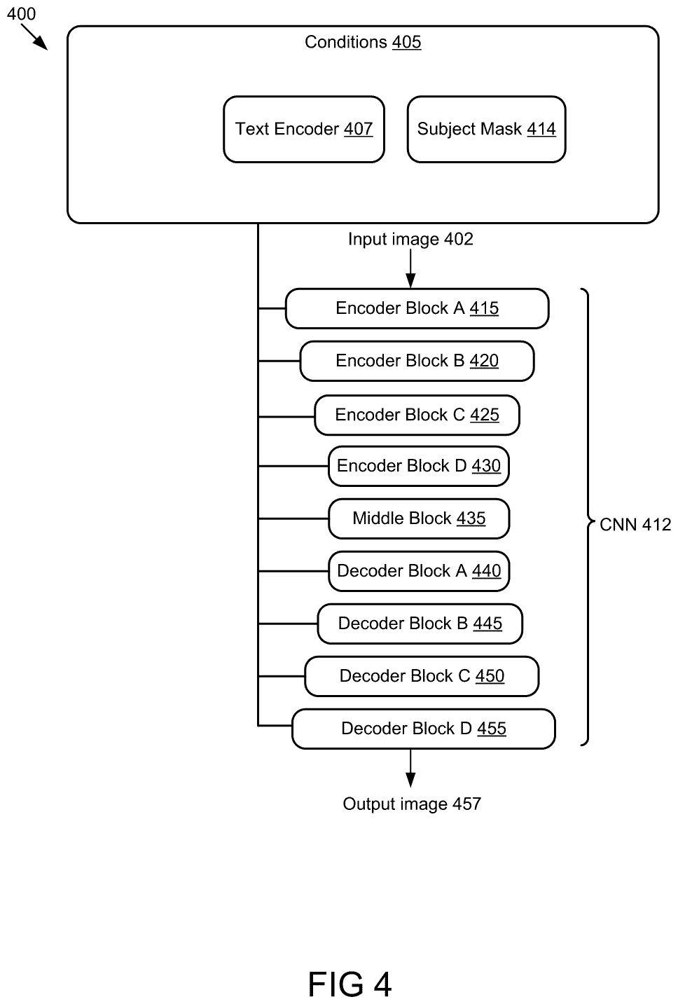

FIG. 4 is a block diagram illustrating an example diffusion model 400, which can be used as an inpainter machine-learning model according to some embodiments described herein. The diffusion model 400 is trained using training data that includes input images 402 (e.g., pairs of a ground truth images and a corresponding masked image) and conditions 405.

The conditions 405 may include a text encoder 407 and a subject mask 414. The text encoder 407 encodes a textual request (e.g., a request to generate an output image that generates an uncropped version and/or a recomposed version of an input image) by converting the text to tokens and converting the tokens into a numerical format.

In some embodiments, the conditions include a subject mask 414 and not a text encoder 407. The subject mask 414 identifies human pixels that are to be preserved during generation of the output image 457. For example, the subject mask 414 may include a face of a subject that is to be left unmodified by the inpainter model, indicating that the rest of the subject can be modified during diffusion. In another example, the body of the subject is included in the subject mask 414. In yet another example, the subject mask 414 may include the human subject's hair if the user wants their hair to remain the same, the human subject's fingers, the human subject's entire body where the subject is a pet to prevent the pet from being overly modified, etc. In some embodiments where the output image modifies the clothing of the human subject, the subject mask 414 excludes pixels of the clothing of the human subject and instead includes the remaining pixels associated with the human subject to prevent modification to the human subject.

The conditions 405 are fed into a Convolutional Neural Network (CNN) 412. The CNN 412 includes a series of encoder blocks, specifically encoder block A 415, encoder block B 420, encoder block C 425, and encoder block D 430. While FIG. 4 shows four encoder blocks, in various embodiments, fewer or higher numbers of encoder blocks can be used. Following the encoder blocks is a middle block 435. The CNN 412 also includes a series of skip-connected decoder blocks, specifically decoder block A 440, decoder Block b 445, decoder block C 450, and decoder block D 455. While FIG. 4 shows four decoder blocks, in various embodiments, fewer or higher numbers of decoder blocks can be used. The CNN 412 generates an output image 457.

The input images 402 are provided as input to a first layer of a CNN 412 and the conditions 405 are provided as input to each block within the CNN 412. In some embodiments, the diffusion model 400 contains 25 blocks where 8 blocks are down-sampling or up-sampling convolutional layers. Other numbers of blocks are possible.

In some embodiments, during training, the inpainter module 206 performs preprocessing on input images 402 to convert the input images 402 from pixel-space images to latent images. Pixel space is where image data is represented directly as pixels; latent space is a compressed, mathematical representation of images. The inpainter module 206 performs training by converting one or more of the conditions 405 from an input size to a feature space vector that matches the size of the CNN 412. For example, the text encoder 407 encodes textual requests into tokens.

During training, the inpainter module 206 provides an input image 402 to the diffusion model 400. The diffusion model 400 progressively adds noise to the input image 402 with each iteration of the diffusion model 400 to produce a noisy image. Given a set of conditions 405, image diffusion models are trained to predict the noise added to the noisy image. The inpainter module 206 may train the diffusion model 400 to generate a plurality of output images that satisfy the textual requests and that do not include human pixels that correspond to the location of the subject mask 414 by progressively removing the noise.

In some embodiments, the inpainter module 206 obtains training data by receiving ground truth images that include subjects. The subjects may be a person, an animal, a person with an animal, a pet, etc. The inpainter module 206 masks one or more borders in each ground truth image. The masked portion of the ground truth image may include varying widths and/or heights in order to train the inpainter machine-learning model to generate inpainted pixels for a variety of input images. The masked portion does not overlap with a subject. In some embodiments, the masking does not mask more than a predetermined amount of the ground truth images (e.g., 20%, 33%, etc.). The masked images are paired with corresponding ground truth images to form a set of training images.

### Training Data for Inpainter Machine-Learning Model

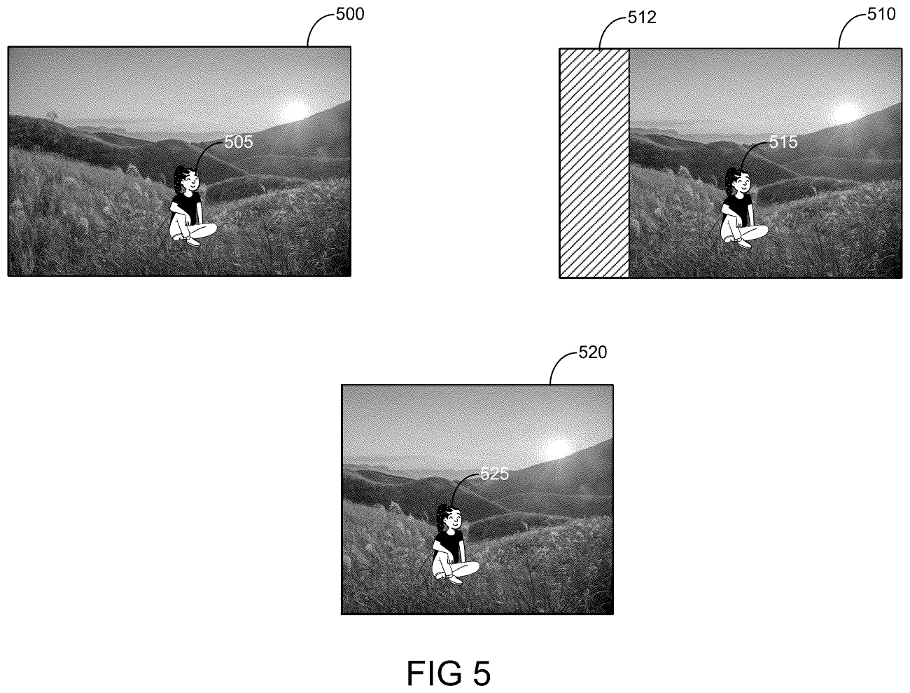

Turning to FIG. 5, example images 500, 510, 520 are illustrated that are used for training, according to some embodiments described herein. The ground truth image 500 includes a subject 505 that is in the center of the ground truth image 500. The inpainter module 206 masks a border 512 of the image 510 (i.e., the left-hand size of the image 510) such that the masked portion does not include the subject 515, to form a masked image 520. The masked image 520 includes the subject 525 in an off-of-center location by masking more of the left-hand side of the image than the right-hand side. The ground truth image 500 and the masked image 510 or 520 are combined as individual pairs for a set of training images.

In some embodiments, the inpainter module 206 receives feedback, such as a rating of the ground truth images from one or more users. The rating may include numbers on a scale, such as in the example illustrated in FIG. 3. The inpainter module 206 may use the ratings as labels associated with the ground truth images. For example, the inpainter module 206 may train an inpainter machine-learning model to generate output images with threshold quality score (e.g., the inpainter machine-learning model may be provided with an instruction to generate output images with a quality rating of at least 8 out of 10).

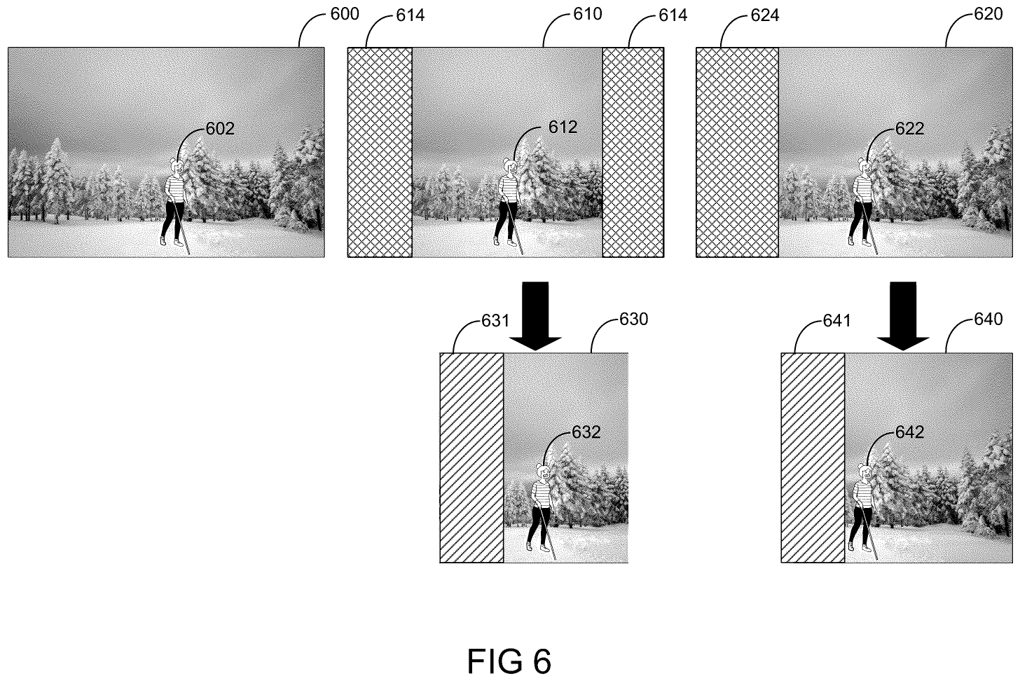

In some embodiments, the inpainter module 206 trains the inpainter machine-learning model using different types of ground truth images that were rated by users based on different types of crops of a ground truth image and different positions of the subject. FIG. 6 illustrates an example of using an initial image 600 to create two different ground truth images 610, 620 with different quality scores, according to according to some embodiments described herein.

FIG. 6 illustrates an initial image 600 that includes a subject 602 in the center of the initial image 600. The inpainter module 206 generates two different cropped ground truth images 610, 620. The first cropped ground truth image 610 is cropped on both sides 614 to keep the subject 612 in the center of the first cropped ground truth image 610. As a result, the first cropped ground truth image 610 may have the highest rating. The second cropped ground truth image 620 is cropped on one side 624, resulting in the subject 622 being positioned off-of-center in the image. As a result, the second cropped ground truth image 620 is associated with a lower rating than the first cropped ground truth image 610.

The inpainter module 206 masks a border 631 of the first cropped ground truth image 610 to create a first masked image 630 and masks a border 641 of the second cropped ground truth image 620 to create a second masked image 640. The inpainter module 206 pairs the first masked image 630 with the first cropped ground truth image 610 and the second masked image 640 with the second cropped corresponding ground truth image 620. The inpainter module 206 is trained to generate the cropped ground truth images 610, 620 from the masked images 630, 640.

In some embodiments, the inpainter module 206 receives feedback from one or more users that includes ratings for the first cropped ground truth image 610 and the second cropped ground truth image 620. The rating for the first cropped ground truth image 610 is higher than the second cropped ground truth image 620 because the subject 612 in the first cropped ground truth image 610 is more centered than the subject 622 in the second cropped ground truth image 620. The inpainter module 206 associates the corresponding ratings with the pairs of images as labels.

The recomposition module 208 includes a recomposition machine-learning model that may receive the output image from the inpainter module 206 and output a recomposition of the output image that removes one or more portions of the input image (i.e., performs cropping). In some embodiments, the recomposition module 208 is a machine-learning model that is trained using pairs of recomposed ground truth images that are cropped versions of original input images. For example, the recomposed ground truth images may be cropped horizontally and/or cropped vertically to remove pixels from the original input images.

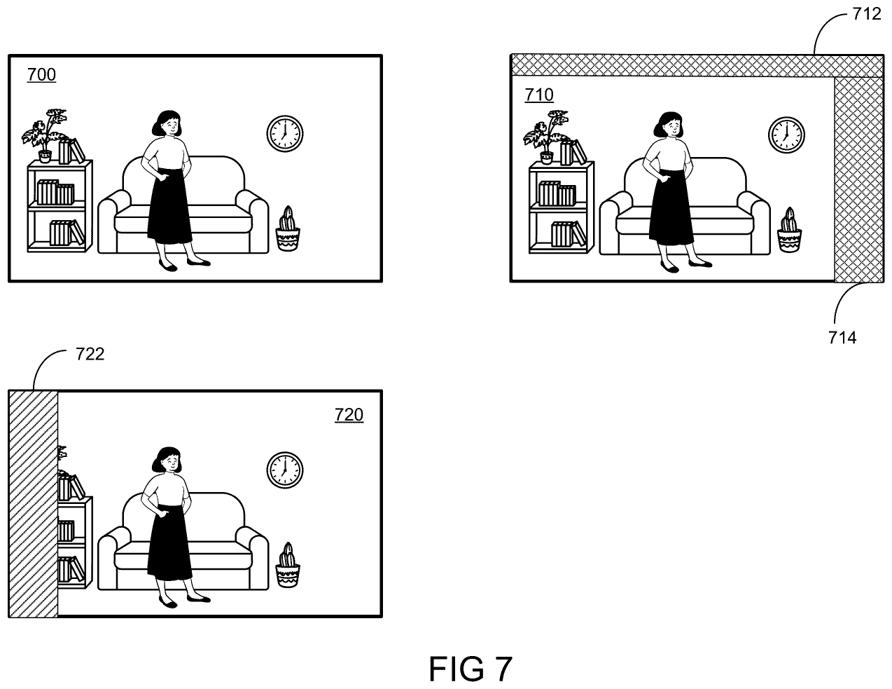

FIG. 7 illustrates an example process for creating a recomposed ground truth image 710 for training data, according to some embodiments described herein. In this example, the recomposition module 208 modifies an initial image 700 to create a recomposed ground truth image 710 by cropping from the top 712 and the side 714. The inpainter module 206 (or the recomposition module 208) masks a border 722 of the initial image 700 to create a masked image 720. The recomposition module 208 pairs the recomposed ground truth image 710 with the masked image 720 as a pair for a set of training images.

Once the inpainter machine-learning model is trained, the inpainter machine-learning model receives an input image and a subject mask that includes subject pixels associated with a subject. The inpainter machine-learning model generates an output image that extends one or more borders of the input image by adding inpainted pixels to the input image (uncrop). In some embodiments, the output image extends the one or more borders of the input image in order to center the subject horizontally in the output image. The recomposition machine-learning model may remove portions of the output image to further improve the image, for example, by cropping from the top or bottom to center the subject vertically (recomposition).

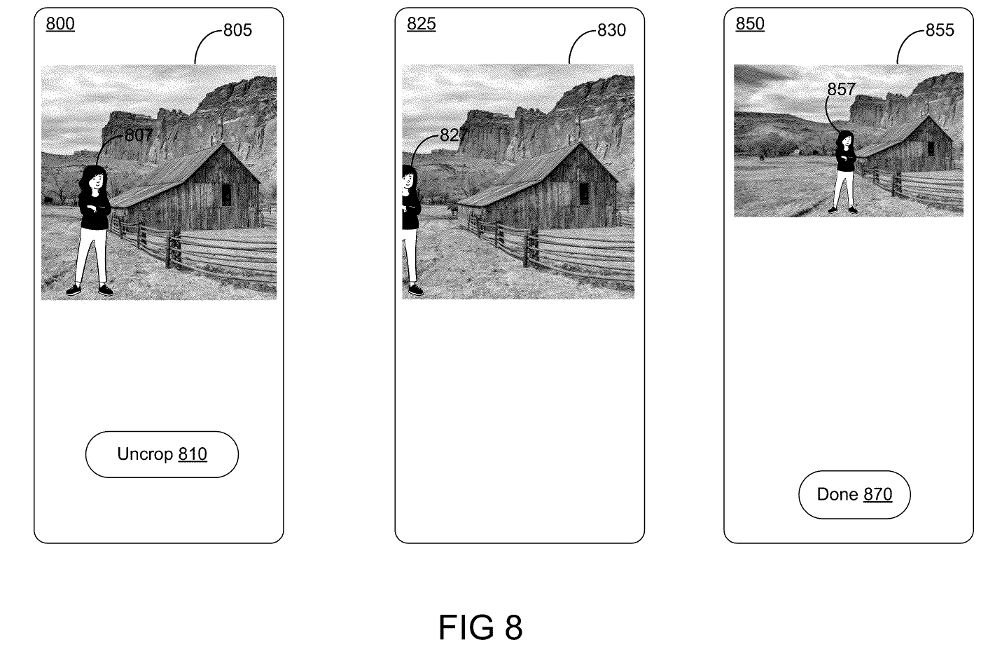

FIG. 8 illustrates example user interfaces 800, 825, 850 for different types of images, according to some embodiments described herein. The first user interface 800 includes an initial image 805 with a subject 807. The segmenter 204 determines that the user is not overlapping with one or more borders. The user interface module 202 provides a suggestion to uncrop the image by selecting the uncrop button 810.

The second user interface 825 includes an initial image 830 with a subject 827 that is overlapping with a border. As a result, the user interface module 202 does not provide a suggestion to uncrop the image.

The third user interface 850 includes an output image 855 that is generated responsive to a user selecting the uncrop button 810 that is part of the first user interface 800. The inpainter machine-learning model generates the output image 855 with the subject 857 in the center of the output image 855. Once the user is satisfied with the output image 855, the user may select the done button 870.

### EXAMPLE METHODS

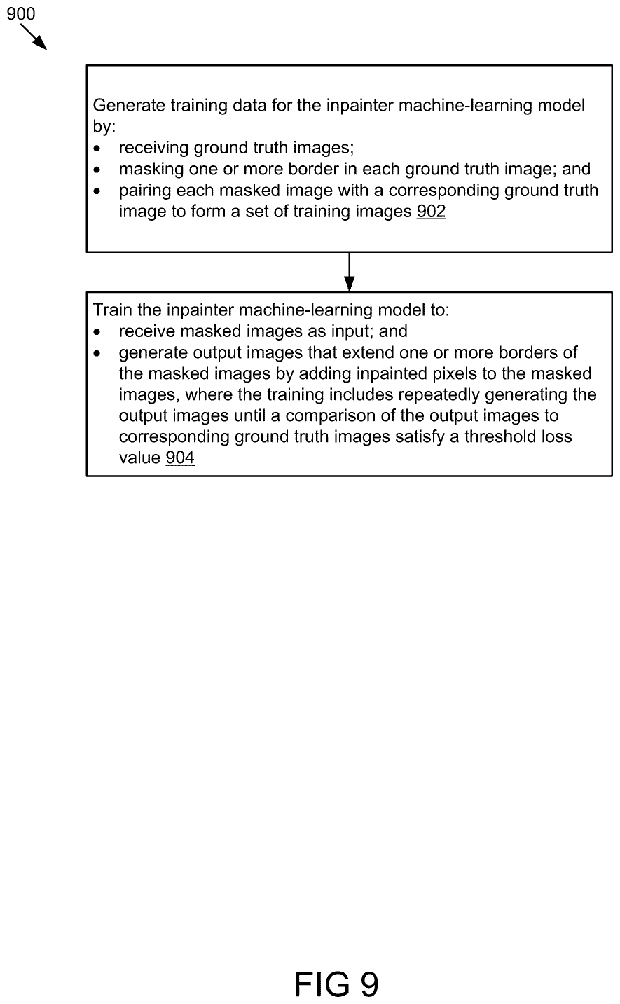

FIG. 9 is a flowchart illustrating an example method 900 to train an inpainter machine-learning model to uncrop an input image, according to some embodiments described herein. The method 900 may be performed by the computing device 200 in FIG. 2. In some embodiments, the method 900 is performed by the user device 115, the media server 101, or in part on the user device 115 and in part on the media server 101.

The method 900 of FIG. 9 may begin at block 902. At block 902, training data for the inpainter machine-learning model is generated by: receiving ground truth images; masking one or more borders in each ground truth images; and pairing each masked image with a corresponding ground truth image to form a set of training images.

In some embodiments, the inpainter machine-learning model is further trained to extend the one or more borders of the input image by an amount that places the subject in a center of the output image. In some embodiments, the inpainter machine-learning model is further trained by: presenting the ground truth images to one or more users; receiving feedback from the one or more users that includes a rating for each of the ground truth images; and training the inpainter model based on ratings associated with the ground truth images. The one or more users may be trained to identify a quality of the ground truth images. In some embodiments, the inpainter machine-learning model is further trained by: receiving initial images; for each of the initial images, cropping one or more borders to form a ground truth image; for each of the initial images, making one or more borders to form one or more masked images; and pairing each masked image with a corresponding ground truth image to form the set of training images, wherein each corresponding ground truth image is a recomposition of the masked image.

In some embodiments, generating training data for the inpainter machine-learning model further includes: cropping the ground truth images to create first cropped ground truth images and second cropped ground truth images, wherein the first cropped ground truth images include the image subject in a center of the first cropped ground truth images and the second cropped ground truth images include the image subject off-of-center; generating a user interface that includes the first cropped ground truth images and the second cropped ground truth images; receiving feedback from one or more users that includes ratings for each of the first cropped ground truth images and the second cropped ground truth images; masking one or more borders in each of the first cropped ground truth images and the second cropped ground truth images; and grouping each masked image with a corresponding first cropped ground truth image and a corresponding second cropped ground truth image to form the set of training images, wherein the set of training images include corresponding ratings. Block 902 may be followed by block 904.

At block 904, the inpainter machine-learning model is trained to: receive masked images as input; and generate output images that extend one or more borders of the masked images by adding inpainted pixels to the masked images, where the training includes repeatedly generating the output images until a comparison of the output images to corresponding ground truths image satisfy a threshold loss value. In some embodiments, the inpainted pixels are based on a similarity to original pixels in the input image and the similarity is a function of a distance from a particular inpainted pixel to a particular original pixel.

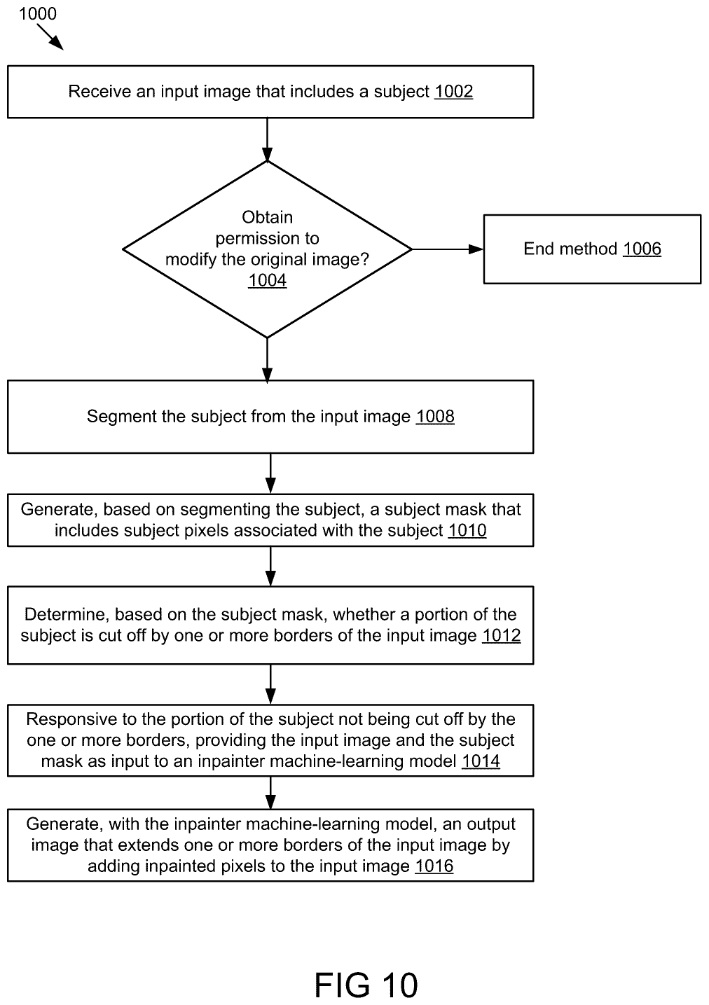

FIG. 10 is a flowchart of an example method 1000 to generate an output image that is uncropped from an input image, according to some embodiments described herein. The method 1000 may be performed by the computing device 200 in FIG. 2. In some embodiments, the method 1000 is performed by the user device 115, the media server 101, or in part on the user device 115 and in part on the media server 101.

The method 1000 may begin with block 1002. At block 1002, an input image that includes the subject is received, Block 1002 may be followed by block 1004.

At block 1004, it is determined whether permission is obtained to modify the original image. If permission is not obtained, block 1004 may be followed by block 1006. If permission is obtained, block 1004 may be followed by block 1008.

At block 1008, the subject is segmented from the input image. Block 1008 may be followed by block 1010.

At block 1010, a subject mask that includes subject pixels associated with the subject are generated based on segmenting the subject. Block 1010 may be followed by block 1012.

At block 1012, it is determined, based on the subject mask, whether a portion of the subject is cut off by one or more borders of the input image. Block 1012 may be followed by block 1014.

At block 1014, responsive to the portion of the subject not being cut off by the one or more borders, the input image and the subject mask are provided as input to an inpainter machine-learning model. Block 1014 may be followed by block 1016.

At block 1016, the inpainter machine-learning model generates an output image that extends one or more borders of the input image by adding inpainted pixels to the input image. In some embodiments, the inpainter machine-learning model extends the one or more borders of the input image by an amount that places the subject in a center of the output image. In some embodiments, generating the output image includes recomposition of the input image such that one or more portions associated with the input image are removed.

As shown above, the present disclosure relates to a media application that receives an input image that includes a subject. The media application segments the subject from the input image. The media application generates, based on segmenting the subject, a subject mask that includes subject pixels associated with the subject. The media application determines, based on the subject mask, whether a portion of the subject is cut off by one or more borders of the input image. Responsive to the portion of the subject not being cut off, the media application provides the input image and the subject mask as input to an inpainter machine-learning model. The media application generates, with the inpainter machine-learning model, an output image that extends one or more borders of the input image by adding inpainted pixels to the input image.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one embodiment of the description. The appearances of the phrase “in some embodiments” in various places in the specification are not necessarily all referring to the same embodiments.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMS, EPROMs, EEPROMs, magnetic or optical cards, flash memories including universal serial bus (USB) keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computer-implemented method to uncrop an input image, the method comprising:
receiving an input image that includes a subject;
segmenting the subject from the input image;
generating, based on segmenting the subject, a subject mask that includes subject pixels associated with the subject;
determining, based on the subject mask, whether a portion of the subject is cut off by one or more borders of the input image;
responsive to the portion of the subject not being cut off by the one or more borders, providing the input image and the subject mask as input to an inpainter machine-learning model; and
generating, with the inpainter machine-learning model, an output image that extends one or more borders of the input image by adding inpainted pixels to the input image.

2. The method of claim 1, wherein the inpainter machine-learning model extends the one or more borders of the input image by an amount that places the subject in a center of the output image.

3. The method of claim 1, wherein generating the output image includes recomposition of the input image such that one or more portions associated with the input image are removed.

4. The method of claim 1, wherein the inpainter machine-learning model is trained using training data and the method further includes generating a set of training images as the training data by:
receiving ground truth images;
masking one or more borders in each ground truth image; and
pairing each masked image with a corresponding ground truth image to form the set of training images.

5. The method of claim 4, wherein the inpainter machine-learning model is trained by:
providing a user interface that includes the ground truth images to one or more users;
receiving feedback from the user that includes a rating for each of the ground truth images; and
training the inpainter model based on ratings associated with the ground truth images.

6. The method of claim 1, wherein the inpainter machine-learning model is trained using training data and the method further includes generating a set of training images as the training data by:
receiving initial images;
for each of the initial images, cropping one or more borders to form a ground truth image;
for each of the initial images, making one or more borders to form one or more masked images; and
pairing each masked image with a corresponding ground truth image to form the set of training images, wherein each corresponding ground truth image is a recomposition of the masked image.

7. The method of claim 1, wherein the inpainter machine-learning model is trained using training data and the method further includes generating a set of training images as the training data by:
receiving ground truth images, each ground truth image having an image subject;
cropping the ground truth images to create first cropped ground truth images and second cropped ground truth images, wherein the first cropped ground truth images include the image subject in a center of the first cropped ground truth images and the second cropped ground truth images include the image subject off-of-center;
generating a user interface that includes the first cropped ground truth images and the second cropped ground truth images;
receiving feedback from one or more users that includes ratings for each of the first cropped ground truth images and the second cropped ground truth images;
masking one or more borders in each of the first cropped ground truth images and the second cropped ground truth images; and
grouping each masked image with a corresponding first cropped ground truth image and a corresponding second cropped ground truth image to form the set of training images, wherein the set of training images include corresponding ratings.

8. The method of claim 1, wherein generating the output image includes:
determining whether the subject is a person is in the input image; and
responsive to the subject being the person, applying a subject mask to the person during generation of the output image to prevent modification of at least a face of the person.

9. The method of claim 1, wherein the inpainted pixels are based on a similarity to original pixels in the input image and the similarity is a function of a distance from a particular inpainted pixel to a particular original pixel.

10. A method to train an inpainter machine-learning model to uncrop an input image, the method comprising:
generating training data for the inpainter machine-learning model by:
receiving ground truth images that include a subject;
masking one or more borders in each ground truth image; and
pairing each masked image with a corresponding ground truth image to form a set of training images; and
training the inpainter machine-learning model to:
receive masked images as input; and
generate output images that extend one or more borders of the masked images by adding inpainted pixels to the masked images, wherein the training includes repeatedly generating the output images until a comparison of the output images to corresponding ground truth images satisfy a threshold loss value.

11. The method of claim 10, wherein the inpainter machine-learning model is further trained to extend the one or more borders of the masked images by an amount that places the subject in a center of the output image.

12. The method of claim 10 wherein generating the training data further comprises:
presenting the corresponding ground truth images to one or more users;
receiving feedback from the one or more users that includes a rating for each of the corresponding ground truth images; and
wherein training the inpainter model is based on ratings associated with the corresponding ground truth images.

13. The method of claim 10, wherein generating training data for the inpainter machine-learning model further comprises:
cropping the ground truth images to create first cropped ground truth images and second cropped ground truth images, wherein the first cropped ground truth images include subjects in a center of the first cropped ground truth images and the second cropped ground truth images include the subject off-of-center;
generating a user interface that includes the first cropped ground truth images and the second cropped ground truth images;
receiving feedback from one or more users that includes ratings for each of the first cropped ground truth images and the second cropped ground truth images;
masking one or more borders in each of the first cropped ground truth images and the second cropped ground truth images; and
grouping each masked image with a corresponding first cropped ground truth image and a corresponding second cropped ground truth image to form the set of training images, wherein the set of training images include corresponding ratings.

14. The method of claim 10, wherein the inpainted pixels are based on a similarity to original pixels in the input image and the similarity is a function of a distance from a particular inpainted pixel to a particular original pixel.

15. A non-transitory computer-readable medium with instructions stored thereon that, when executed by one or more processors, cause the one or more processors to perform operations comprising:
receiving an input image that includes a subject;
segmenting the subject from the input image;
generating, based on segmenting the subject, a subject mask that includes subject pixels associated with the subject;
determining, based on the subject mask, whether a portion of the subject is cut off by one or more borders of the input image;
responsive to the portion of the subject not being cut off by the one or more borders, providing the input image and the subject mask as input to an inpainter machine-learning model; and
generating, with the inpainter machine-learning model, an output image that extends one or more borders of the input image by adding inpainted pixels to the input image.

16. The non-transitory computer-readable medium of claim 15, wherein the inpainter machine-learning model extends the one or more borders of the input image by an amount that places the subject in a center of the output image.

17. The non-transitory computer-readable medium of claim 15, wherein generating the output image includes recomposition of the input image such that one or more portions associated with the input image are removed.

18. The non-transitory computer-readable medium of claim 17, wherein the inpainter machine-learning model is trained using training data and the operations further include generating a set of training images as the training data by:
receiving ground truth images;
masking one or more borders in each ground truth image; and
pairing each masked image with a corresponding ground truth image to form the set of training images.

19. The non-transitory computer-readable medium of claim 18, wherein the inpainter machine-learning model is trained by:
providing a user interface that includes the ground truth images to one or more users;
receiving feedback from the user that includes a rating for each of the ground truth images; and
training the inpainter model based on ratings associated with the ground truth images.

20. The non-transitory computer-readable medium of claim 15, wherein the inpainter machine-learning model is trained using training data and the operations further include generating a set of training images as the training data by:
receiving initial images;
for each of the initial images, cropping one or more borders to form a ground truth image;
for each of the initial images, making one or more borders to form one or more masked images; and
pairing each masked image with a corresponding ground truth image to form the set of training images, wherein each corresponding ground truth image is a recomposition of the masked image.
